(19) United States
(12) Patent Application Publication
(10) Pub. No.: US 2025/0317399 A1
(43) Pub. Date: Oct. 9, 2025

(54) SYSTEMS AND METHODS OF LATENCY IMPROVEMENT

(71) Applicant: Meta Platforms Technologies, LLC, Menlo Park, CA (US)

(72) Inventors: Yousef Abdelmalek, New Providence, NJ (US); Mitesh Dave, San Diego, CA (US); Heshaam Elbatouti, Summit, NJ (US); Prasannakumar Mallappa, Union City, CA (US)

(73) Assignee: Meta Platforms Technologies, LLC, Menlo Park, CA (US)

(21) Appl. No.: 19/080,761

(22) Filed: Mar. 14, 2025

Related U.S. Application Data
(60) Provisional application No. 63/575,242, filed on Apr. 5, 2024.

(51) Int. Cl. H04L 47/24; H04L 47/12; H04L 47/36

(52) U.S. Cl. CPC H04L 47/24; H04L 47/12; H04L 47/365

(57) ABSTRACT

Systems and methods for latency improvement may include a first endpoint which is configured to transmit, via one or more intermediary network devices to a second endpoint, first traffic generated by the first endpoint for receipt by the second endpoint. The first endpoint may receive, from a first intermediary network device of the one or more intermediary network devices, a packet generated by the first intermediary network device, the packet indicating congestion experienced by the first intermediary network device. The first endpoint may transmit, via the one or more intermediary network devices to the second endpoint, second traffic generated by the first endpoint according to the packet received from the first intermediary network device.

### CROSS-REFERENCE TO RELATED APPLICATIONS

This application claims the benefit of and priority to U.S. Application No. 63/575,242, filed Apr. 5, 2024, the contents of which are incorporated herein by reference in their entirety.

### FIELD OF DISCLOSURE

The present disclosure is generally related to wireless communication, including but not limited to, systems and methods for latency improvement.

### BACKGROUND

Augmented reality (AR), virtual reality (VR), and mixed reality (MR) are becoming more prevalent, which such technology being supported across a wider variety of platforms and device. Some AR/VR/MR devices may communicate with one or more other remote devices via a cellular connection.

### SUMMARY

In one aspect, this disclosure relates to a method. The method may include transmitting, by a first endpoint via one or more intermediary network devices to a second endpoint, first traffic generated by the first endpoint for receipt by the second endpoint. The method may include receiving, by the first endpoint from a first intermediary network device of the one or more intermediary network devices, a packet generated by the first intermediary network device. The packet may indicate congestion experienced by the first intermediary network device. The method may include transmitting, by the first endpoint via the one or more intermediary network devices to the second endpoint, second traffic generated by the first endpoint according to the packet received from the first intermediary network device.

In some embodiments, the first intermediary network device includes at least one of an access point or a base station. In some embodiments, the packet includes an internet control message protocol (ICMP) packet generated by the first intermediary network device. In some embodiments, the ICMP packet includes a source quench message generated by the first intermediary network device and transmitted to the first endpoint. In some embodiments, the first traffic and the second traffic include latency sensitive traffic, and the first intermediary network device generates the packet according to a request for low latency, low loss, scalable throughput (L4S) generated by at least one of the first endpoint or the second endpoint.

In some embodiments, the method further includes generating, by the first endpoint, the second traffic according to the packet received from the first intermediary network device. In some embodiments, the first endpoint generates the second traffic by setting a codec rate for generation of the second traffic, which is different than a codec rate used for generating the first traffic. In some embodiments, the first endpoint includes a user device or an application server. In some embodiments, the one or more intermediary network devices include the first intermediary device and one or more second intermediary network devices, the one or more second intermediary network devices corresponding to at least one of an internet service provider (ISP) network or a cellular network. In some embodiments, the first traffic and the second traffic include at least one of first and second uplink traffic or first and second downlink traffic.

In another aspect, this disclosure relates to a first endpoint including one or more processors configured to transmit, via one or more intermediary network devices to a second endpoint, first traffic generated by the first endpoint for receipt by the second endpoint. The one or more processors may be configured to receive, from a first intermediary network device of the one or more intermediary network devices, a packet generated by the first intermediary network device. The packet may indicate congestion experienced by the first intermediary network device. The one or more processors may be configured to transmit, via the one or more intermediary network devices to the second endpoint, second traffic generated by the first endpoint according to the packet received from the first intermediary network device.

In some embodiments, the first intermediary network device includes at least one of an access point or a base station. In some embodiments, the packet includes an internet control message protocol (ICMP) packet generated by the first intermediary network device. In some embodiments, the ICMP packet includes a source quench message generated by the first intermediary network device and transmitted to the first endpoint. In some embodiments, the first traffic and the second traffic include latency sensitive traffic, and the first intermediary network device generates the packet according to a request for low latency, low loss, scalable throughput (L4S) generated by at least one of the first endpoint or the second endpoint.

In some embodiments, the one or more processors are configured to generate the second traffic according to the packet received from the first intermediary network device. In some embodiments, the one or more processors are configured to generate the second traffic by setting a codec rate for generation of the second traffic, which is different than a codec rate used for generating the first traffic. In some embodiments, the first endpoint includes a user device or an application server. In some embodiments, the one or more intermediary network devices include the first intermediary device and one or more second intermediary network devices, the one or more second intermediary network devices corresponding to at least one of an internet service provider (ISP) network or a cellular network.

In yet another aspect, this disclosure relates to a non-transitory computer readable medium storing instructions that, when executed by one or more processors of a first endpoint, cause the one or more processors to transmit, via one or more intermediary network devices to a second endpoint, first traffic generated by the first endpoint for receipt by the second endpoint. The instructions may cause the one or more processors to receive, from a first intermediary network device of the one or more intermediary network devices, a packet generated by the first intermediary network device. The packet may indicate congestion experienced by the first intermediary network device. The instructions may cause the one or more processors to transmit, via the one or more intermediary network devices to the second endpoint, second traffic generated by the first endpoint according to the packet received from the first intermediary network device.

### BRIEF DESCRIPTION OF THE DRAWINGS

The accompanying drawings are not intended to be drawn to scale. Like reference numbers and designations in the various drawings indicate like elements. For purposes of clarity, not every component can be labeled in every drawing.

FIG. 1 is a diagram of an example wireless communication system, according to an example implementation of the present disclosure.

FIG. 2 is a diagram of a console and a head wearable display for presenting augmented reality or virtual reality, according to an example implementation of the present disclosure.

FIG. 3 is a diagram of a head wearable display, according to an example implementation of the present disclosure.

FIG. 4 is a block diagram of a computing environment according to an example implementation of the present disclosure.

FIG. 5 is a network diagram of a system for latency improvement, according to an example implementation of the present disclosure.

FIG. 6 depicts various examples of congestion indication for downlink and uplink traffic, according to an example implementation of the present disclosure.

FIG. 7 is a block diagram of the system of FIG. 5, according to an example implementation of the present disclosure.

FIG. 8 is a process flow diagram for latency improvement for downlink traffic, according to an example implementation of the present disclosure.

FIG. 9 is a process flow diagram for latency improvement for uplink traffic, according to an example implementation of the present disclosure.

FIG. 10 is a flowchart showing an example method for latency improvement, according to an example implementation of the present disclosure.

### DETAILED DESCRIPTION

Before turning to the figures, which illustrate certain embodiments in detail, it should be understood that the present disclosure is not limited to the details or methodology set forth in the description or illustrated in the figures. It should also be understood that the terminology used herein is for the purpose of description only and should not be regarded as limiting.

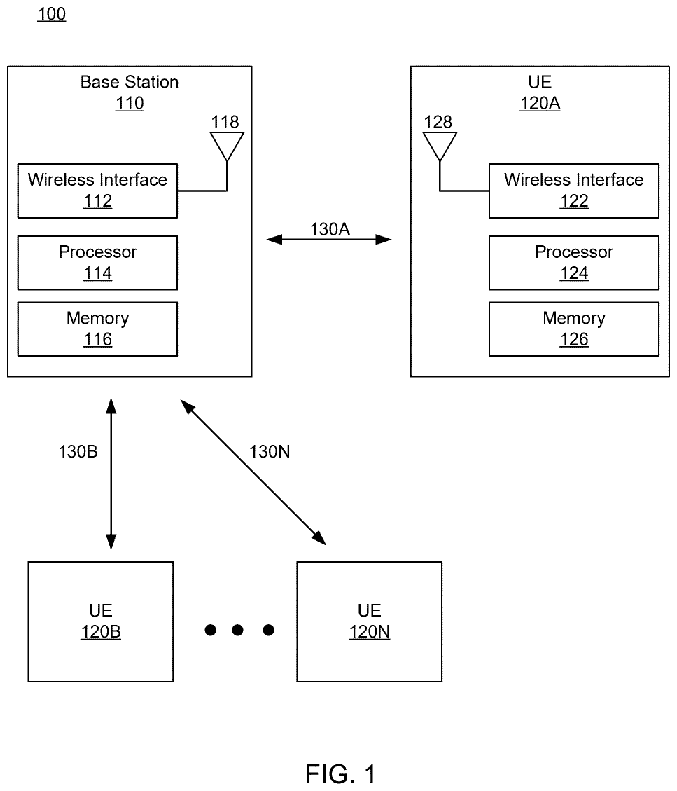

FIG. 1 illustrates an example wireless communication system 100. The wireless communication system 100 may include a base station 110 (also referred to as “a wireless communication node 110” or “a station 110”) and one or more user equipment (UEs) 120 (also referred to as “wireless communication devices 120” or “terminal devices 120”). The base station 110 and the UEs 120 may communicate through wireless commination links 130A, 130B, 130C. The wireless communication link 130 may be a cellular communication link conforming to 3G, 4G, 5G or other cellular communication protocols or a Wi-Fi communication protocol. In one example, the wireless communication link 130 supports, employs or is based on an orthogonal frequency division multiple access (OFDMA). In one aspect, the UEs 120 are located within a geographical boundary with respect to the base station 110, and may communicate with or through the base station 110. In some embodiments, the wireless communication system 100 includes more, fewer, or different components than shown in FIG. 1. For example, the wireless communication system 100 may include one or more additional base stations 110 than shown in FIG. 1.

In some embodiments, the UE 120 may be a user device such as a mobile phone, a smart phone, a personal digital assistant (PDA), tablet, laptop computer, wearable computing device, etc. Each UE 120 may communicate with the base station 110 through a corresponding communication link 130. For example, the UE 120 may transmit data to a base station 110 through a wireless communication link 130, and receive data from the base station 110 through the wireless communication link 130. Example data may include audio data, image data, text, etc. Communication or transmission of data by the UE 120 to the base station 110 may be referred to as an uplink communication. Communication or reception of data by the UE 120 from the base station 110 may be referred to as a downlink communication. In some embodiments, the UE 120A includes a wireless interface 122, a processor 124, a memory device 126, and one or more antennas 128. These components may be embodied as hardware, software, firmware, or a combination thereof. In some embodiments, the UE 120A includes more, fewer, or different components than shown in FIG. 1. For example, the UE 120 may include an electronic display and/or an input device. For example, the UE 120 may include additional antennas 128 and wireless interfaces 122 than shown in FIG. 1.

The antenna 128 may be a component that receives a radio frequency (RF) signal and/or transmit a RF signal through a wireless medium. The RF signal may be at a frequency between 200 MHz to 100 GHz. The RF signal may have packets, symbols, or frames corresponding to data for communication. The antenna 128 may be a dipole antenna, a patch antenna, a ring antenna, or any suitable antenna for wireless communication. In one aspect, a single antenna 128 is utilized for both transmitting the RF signal and receiving the RF signal. In one aspect, different antennas 128 are utilized for transmitting the RF signal and receiving the RF signal. In one aspect, multiple antennas 128 are utilized to support multiple-in, multiple-out (MIMO) communication.

The wireless interface 122 includes or is embodied as a transceiver for transmitting and receiving RF signals through a wireless medium. The wireless interface 122 may communicate with a wireless interface 112 of the base station 110 through a wireless communication link 130A. In one configuration, the wireless interface 122 is coupled to one or more antennas 128. In one aspect, the wireless interface 122 may receive the RF signal at the RF frequency received through antenna 128, and downconvert the RF signal to a baseband frequency (e.g., 0˜1 GHz). The wireless interface 122 may provide the downconverted signal to the processor 124. In one aspect, the wireless interface 122 may receive a baseband signal for transmission at a baseband frequency from the processor 124, and upconvert the baseband signal to generate a RF signal. The wireless interface 122 may transmit the RF signal through the antenna 128.

The processor 124 is a component that processes data. The processor 124 may be embodied as field programmable gate array (FPGA), application specific integrated circuit (ASIC), a logic circuit, etc. The processor 124 may obtain instructions from the memory device 126, and executes the instructions. In one aspect, the processor 124 may receive downconverted data at the baseband frequency from the wireless interface 122, and decode or process the downconverted data. For example, the processor 124 may generate audio data or image data according to the downconverted data, and present an audio indicated by the audio data and/or an image indicated by the image data to a user of the UE 120A. In one aspect, the processor 124 may generate or obtain data for transmission at the baseband frequency, and encode or process the data. For example, the processor 124 may encode or process image data or audio data at the baseband frequency, and provide the encoded or processed data to the wireless interface 122 for transmission.

The memory device 126 is a component that stores data. The memory device 126 may be embodied as random access memory (RAM), flash memory, read only memory (ROM), erasable programmable read-only memory (EPROM), electrically erasable programmable read-only memory (EEPROM), registers, a hard disk, a removable disk, a CD-ROM, or any device capable for storing data. The memory device 126 may be embodied as a non-transitory computer readable medium storing instructions executable by the processor 124 to perform various functions of the UE 120A disclosed herein. In some embodiments, the memory device 126 and the processor 124 are integrated as a single component.

In some embodiments, each of the UEs 120B . . . 120N includes similar components of the UE 120A to communicate with the base station 110. Thus, detailed description of duplicated portion thereof is omitted herein for the sake of brevity.

In some embodiments, the base station 110 may be an evolved node B (eNB), a serving eNB, a target eNB, a femto station, or a pico station. The base station 110 may be communicatively coupled to another base station 110 or other communication devices through a wireless communication link and/or a wired communication link. The base station 110 may receive data (or a RF signal) in an uplink communication from a UE 120. Additionally or alternatively, the base station 110 may provide data to another UE 120, another base station, or another communication device. Hence, the base station 110 allows communication among UEs 120 associated with the base station 110, or other UEs associated with different base stations. In some embodiments, the base station 110 includes a wireless interface 112, a processor 114, a memory device 116, and one or more antennas 118. These components may be embodied as hardware, software, firmware, or a combination thereof. In some embodiments, the base station 110 includes more, fewer, or different components than shown in FIG. 1. For example, the base station 110 may include an electronic display and/or an input device. For example, the base station 110 may include additional antennas 118 and wireless interfaces 112 than shown in FIG. 1.

The antenna 118 may be a component that receives a radio frequency (RF) signal and/or transmit a RF signal through a wireless medium. The antenna 118 may be a dipole antenna, a patch antenna, a ring antenna, or any suitable antenna for wireless communication. In one aspect, a single antenna 118 is utilized for both transmitting the RF signal and receiving the RF signal. In one aspect, different antennas 118 are utilized for transmitting the RF signal and receiving the RF signal. In one aspect, multiple antennas 118 are utilized to support multiple-in, multiple-out (MIMO) communication.

The wireless interface 112 includes or is embodied as a transceiver for transmitting and receiving RF signals through a wireless medium. The wireless interface 112 may communicate with a wireless interface 122 of the UE 120 through a wireless communication link 130. In one configuration, the wireless interface 112 is coupled to one or more antennas 118. In one aspect, the wireless interface 112 may receive the RF signal at the RF frequency received through antenna 118, and downconvert the RF signal to a baseband frequency (e.g., 0˜1 GHz). The wireless interface 112 may provide the downconverted signal to the processor 124. In one aspect, the wireless interface 122 may receive a baseband signal for transmission at a baseband frequency from the processor 114, and upconvert the baseband signal to generate a RF signal. The wireless interface 112 may transmit the RF signal through the antenna 118.

The processor 114 is a component that processes data. The processor 114 may be embodied as FPGA, ASIC, a logic circuit, etc. The processor 114 may obtain instructions from the memory device 116, and executes the instructions. In one aspect, the processor 114 may receive downconverted data at the baseband frequency from the wireless interface 112, and decode or process the downconverted data. For example, the processor 114 may generate audio data or image data according to the downconverted data. In one aspect, the processor 114 may generate or obtain data for transmission at the baseband frequency, and encode or process the data. For example, the processor 114 may encode or process image data or audio data at the baseband frequency, and provide the encoded or processed data to the wireless interface 112 for transmission. In one aspect, the processor 114 may set, assign, schedule, or allocate communication resources for different UEs 120. For example, the processor 114 may set different modulation schemes, time slots, channels, frequency bands, etc. for UEs 120 to avoid interference. The processor 114 may generate data (or UL CGs) indicating configuration of communication resources, and provide the data (or UL CGs) to the wireless interface 112 for transmission to the UEs 120.

The memory device 116 is a component that stores data. The memory device 116 may be embodied as RAM, flash memory, ROM, EPROM, EEPROM, registers, a hard disk, a removable disk, a CD-ROM, or any device capable for storing data. The memory device 116 may be embodied as a non-transitory computer readable medium storing instructions executable by the processor 114 to perform various functions of the base station 110 disclosed herein. In some embodiments, the memory device 116 and the processor 114 are integrated as a single component.

In some embodiments, communication between the base station 110 and the UE 120 is based on one or more layers of Open Systems Interconnection (OSI) model. The OSI model may include layers including: a physical layer, a Medium Access Control (MAC) layer, a Radio Link Control (RLC) layer, a Packet Data Convergence Protocol (PDCP) layer, a Radio Resource Control (RRC) layer, a Non Access Stratum (NAS) layer or an Internet Protocol (IP) layer, and other layer.

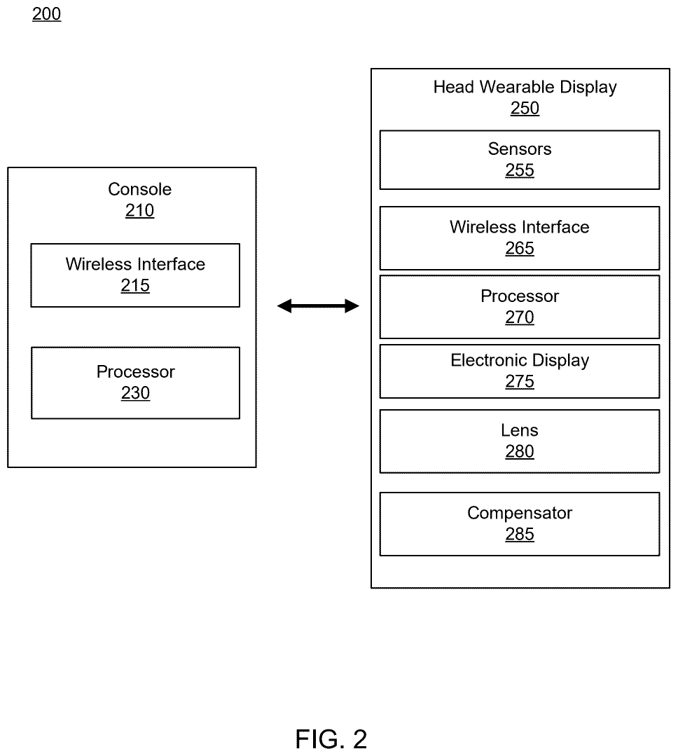

FIG. 2 is a block diagram of an example artificial reality system environment 200. In some embodiments, the artificial reality system environment 200 includes a HWD 250 worn by a user, and a console 210 providing content of artificial reality (e.g., augmented reality, virtual reality, mixed reality) to the HWD 250. Each of the HWD 250 and the console 210 may be a separate UE 120. The HWD 250 may be referred to as, include, or be part of a head mounted display (HMD), head mounted device (HMD), head wearable device (HWD), head worn display (HWD) or head worn device (HWD). The HWD 250 may detect its location and/or orientation of the HWD 250 as well as a shape, location, and/or an orientation of the body/hand/face of the user, and provide the detected location/or orientation of the HWD 250 and/or tracking information indicating the shape, location, and/or orientation of the body/hand/face to the console 210. The console 210 may generate image data indicating an image of the artificial reality according to the detected location and/or orientation of the HWD 250, the detected shape, location and/or orientation of the body/hand/face of the user, and/or a user input for the artificial reality, and transmit the image data to the HWD 250 for presentation. In some embodiments, the artificial reality system environment 200 includes more, fewer, or different components than shown in FIG. 2. In some embodiments, functionality of one or more components of the artificial reality system environment 200 can be distributed among the components in a different manner than is described here. For example, some of the functionality of the console 210 may be performed by the HWD 250. For example, some of the functionality of the HWD 250 may be performed by the console 210. In some embodiments, the console 210 is integrated as part of the HWD 250.

In some embodiments, the HWD 250 is an electronic component that can be worn by a user and can present or provide an artificial reality experience to the user. The HWD 250 may render one or more images, video, audio, or some combination thereof to provide the artificial reality experience to the user. In some embodiments, audio is presented via an external device (e.g., speakers and/or headphones) that receives audio information from the HWD 250, the console 210, or both, and presents audio based on the audio information. In some embodiments, the HWD 250 includes sensors 255, a wireless interface 265, a processor 270, an electronic display 275, a lens 280, and a compensator 285. These components may operate together to detect a location of the HWD 250 and a gaze direction of the user wearing the HWD 250, and render an image of a view within the artificial reality corresponding to the detected location and/or orientation of the HWD 250. In other embodiments, the HWD 250 includes more, fewer, or different components than shown in FIG. 2.

In some embodiments, the sensors 255 include electronic components or a combination of electronic components and software components that detect a location and an orientation of the HWD 250. Examples of the sensors 255 can include: one or more imaging sensors, one or more accelerometers, one or more gyroscopes, one or more magnetometers, or another suitable type of sensor that detects motion and/or location. For example, one or more accelerometers can measure translational movement (e.g., forward/back, up/down, left/right) and one or more gyroscopes can measure rotational movement (e.g., pitch, yaw, roll). In some embodiments, the sensors 255 detect the translational movement and the rotational movement, and determine an orientation and location of the HWD 250. In one aspect, the sensors 255 can detect the translational movement and the rotational movement with respect to a previous orientation and location of the HWD 250, and determine a new orientation and/or location of the HWD 250 by accumulating or integrating the detected translational movement and/or the rotational movement. Assuming for an example that the HWD 250 is oriented in a direction 25 degrees from a reference direction, in response to detecting that the HWD 250 has rotated 20 degrees, the sensors 255 may determine that the HWD 250 now faces or is oriented in a direction 45 degrees from the reference direction. Assuming for another example that the HWD 250 was located two feet away from a reference point in a first direction, in response to detecting that the HWD 250 has moved three feet in a second direction, the sensors 255 may determine that the HWD 250 is now located at a vector multiplication of the two feet in the first direction and the three feet in the second direction.

In some embodiments, the sensors 255 include eye trackers. The eye trackers may include electronic components or a combination of electronic components and software components that determine a gaze direction of the user of the HWD 250. In some embodiments, the HWD 250, the console 210 or a combination of them may incorporate the gaze direction of the user of the HWD 250 to generate image data for artificial reality. In some embodiments, the eye trackers include two eye trackers, where each eye tracker captures an image of a corresponding eye and determines a gaze direction of the eye. In one example, the eye tracker determines an angular rotation of the eye, a translation of the eye, a change in the torsion of the eye, and/or a change in shape of the eye, according to the captured image of the eye, and determines the relative gaze direction with respect to the HWD 250, according to the determined angular rotation, translation and the change in the torsion of the eye. In one approach, the eye tracker may shine or project a predetermined reference or structured pattern on a portion of the eye, and capture an image of the eye to analyze the pattern projected on the portion of the eye to determine a relative gaze direction of the eye with respect to the HWD 250. In some embodiments, the eye trackers incorporate the orientation of the HWD 250 and the relative gaze direction with respect to the HWD 250 to determine a gate direction of the user. Assuming for an example that the HWD 250 is oriented at a direction 30 degrees from a reference direction, and the relative gaze direction of the HWD 250 is −10 degrees (or 350 degrees) with respect to the HWD 250, the eye trackers may determine that the gaze direction of the user is 20 degrees from the reference direction. In some embodiments, a user of the HWD 250 can configure the HWD 250 (e.g., via user settings) to enable or disable the eye trackers. In some embodiments, a user of the HWD 250 is prompted to enable or disable the eye trackers.

In some embodiments, the wireless interface 265 includes an electronic component or a combination of an electronic component and a software component that communicates with the console 210. The wireless interface 265 may be or correspond to the wireless interface 122. The wireless interface 265 may communicate with a wireless interface 215 of the console 210 through a wireless communication link through the base station 110. Through the communication link, the wireless interface 265 may transmit to the console 210 data indicating the determined location and/or orientation of the HWD 250, and/or the determined gaze direction of the user. Moreover, through the communication link, the wireless interface 265 may receive from the console 210 image data indicating or corresponding to an image to be rendered and additional data associated with the image.

In some embodiments, the processor 270 includes an electronic component or a combination of an electronic component and a software component that generates one or more images for display, for example, according to a change in view of the space of the artificial reality. In some embodiments, the processor 270 is implemented as a part of the processor 124 or is communicatively coupled to the processor 124. In some embodiments, the processor 270 is implemented as a processor (or a graphical processing unit (GPU)) that executes instructions to perform various functions described herein. The processor 270 may receive, through the wireless interface 265, image data describing an image of artificial reality to be rendered and additional data associated with the image, and render the image to display through the electronic display 275. In some embodiments, the image data from the console 210 may be encoded, and the processor 270 may decode the image data to render the image. In some embodiments, the processor 270 receives, from the console 210 in additional data, object information indicating virtual objects in the artificial reality space and depth information indicating depth (or distances from the HWD 250) of the virtual objects. In one aspect, according to the image of the artificial reality, object information, depth information from the console 210, and/or updated sensor measurements from the sensors 255, the processor 270 may perform shading, reprojection, and/or blending to update the image of the artificial reality to correspond to the updated location and/or orientation of the HWD 250. Assuming that a user rotated his head after the initial sensor measurements, rather than recreating the entire image responsive to the updated sensor measurements, the processor 270 may generate a small portion (e.g., 10%) of an image corresponding to an updated view within the artificial reality according to the updated sensor measurements, and append the portion to the image in the image data from the console 210 through reprojection. The processor 270 may perform shading and/or blending on the appended edges. Hence, without recreating the image of the artificial reality according to the updated sensor measurements, the processor 270 can generate the image of the artificial reality.

In some embodiments, the electronic display 275 is an electronic component that displays an image. The electronic display 275 may, for example, be a liquid crystal display or an organic light emitting diode display. The electronic display 275 may be a transparent display that allows the user to see through. In some embodiments, when the HWD 250 is worn by a user, the electronic display 275 is located proximate (e.g., less than 3 inches) to the user's eyes. In one aspect, the electronic display 275 emits or projects light towards the user's eyes according to image generated by the processor 270.

In some embodiments, the lens 280 is a mechanical component that alters received light from the electronic display 275. The lens 280 may magnify the light from the electronic display 275, and correct for optical error associated with the light. The lens 280 may be a Fresnel lens, a convex lens, a concave lens, a filter, or any suitable optical component that alters the light from the electronic display 275. Through the lens 280, light from the electronic display 275 can reach the pupils, such that the user can see the image displayed by the electronic display 275, despite the close proximity of the electronic display 275 to the eyes.

In some embodiments, the compensator 285 includes an electronic component or a combination of an electronic component and a software component that performs compensation to compensate for any distortions or aberrations. In one aspect, the lens 280 introduces optical aberrations such as a chromatic aberration, a pin-cushion distortion, barrel distortion, etc. The compensator 285 may determine a compensation (e.g., predistortion) to apply to the image to be rendered from the processor 270 to compensate for the distortions caused by the lens 280, and apply the determined compensation to the image from the processor 270. The compensator 285 may provide the predistorted image to the electronic display 275.

In some embodiments, the console 210 is an electronic component or a combination of an electronic component and a software component that provides content to be rendered to the HWD 250. In one aspect, the console 210 includes a wireless interface 215 and a processor 230. These components may operate together to determine a view (e.g., a FOV of the user) of the artificial reality corresponding to the location of the HWD 250 and the gaze direction of the user of the HWD 250, and can generate image data indicating an image of the artificial reality corresponding to the determined view. In addition, these components may operate together to generate additional data associated with the image. Additional data may be information associated with presenting or rendering the artificial reality other than the image of the artificial reality. Examples of additional data include, hand model data, mapping information for translating a location and an orientation of the HWD 250 in a physical space into a virtual space (or simultaneous localization and mapping (SLAM) data), eye tracking data, motion vector information, depth information, edge information, object information, etc. The console 210 may provide the image data and the additional data to the HWD 250 for presentation of the artificial reality. In other embodiments, the console 210 includes more, fewer, or different components than shown in FIG. 2. In some embodiments, the console 210 is integrated as part of the HWD 250.

In some embodiments, the wireless interface 215 is an electronic component or a combination of an electronic component and a software component that communicates with the HWD 250. The wireless interface 215 may be or correspond to the wireless interface 122. The wireless interface 215 may be a counterpart component to the wireless interface 265 to communicate through a communication link (e.g., wireless communication link). Through the communication link, the wireless interface 215 may receive from the HWD 250 data indicating the determined location and/or orientation of the HWD 250, and/or the determined gaze direction of the user. Moreover, through the communication link, the wireless interface 215 may transmit to the HWD 250 image data describing an image to be rendered and additional data associated with the image of the artificial reality.

The processor 230 can include or correspond to a component that generates content to be rendered according to the location and/or orientation of the HWD 250. In some embodiments, the processor 230 is implemented as a part of the processor 124 or is communicatively coupled to the processor 124. In some embodiments, the processor 230 may incorporate the gaze direction of the user of the HWD 250. In one aspect, the processor 230 determines a view of the artificial reality according to the location and/or orientation of the HWD 250. For example, the processor 230 maps the location of the HWD 250 in a physical space to a location within an artificial reality space, and determines a view of the artificial reality space along a direction corresponding to the mapped orientation from the mapped location in the artificial reality space. The processor 230 may generate image data describing an image of the determined view of the artificial reality space, and transmit the image data to the HWD 250 through the wireless interface 215. In some embodiments, the processor 230 may generate additional data including motion vector information, depth information, edge information, object information, hand model data, etc., associated with the image, and transmit the additional data together with the image data to the HWD 250 through the wireless interface 215. The processor 230 may encode the image data describing the image, and can transmit the encoded data to the HWD 250. In some embodiments, the processor 230 generates and provides the image data to the HWD 250 periodically (e.g., every 11 ms).

In one aspect, the process of detecting the location of the HWD 250 and the gaze direction of the user wearing the HWD 250, and rendering the image to the user should be performed within a frame time (e.g., 11 ms or 16 ms). A latency between a movement of the user wearing the HWD 250 and an image displayed corresponding to the user movement can cause judder, which may result in motion sickness and can degrade the user experience. In one aspect, the HWD 250 and the console 210 can prioritize communication for AR/VR, such that the latency between the movement of the user wearing the HWD 250 and the image displayed corresponding to the user movement can be presented within the frame time (e.g., 11 ms or 16 ms) to provide a seamless experience.

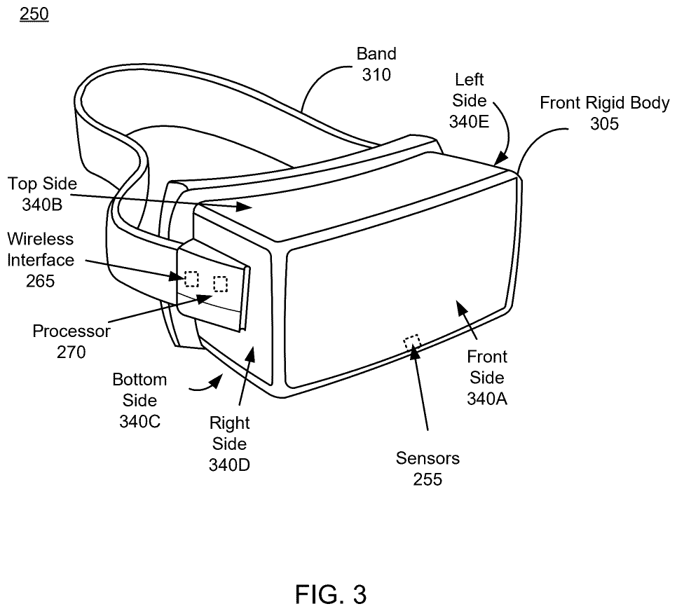

FIG. 3 is a diagram of a HWD 250, in accordance with an example embodiment. In some embodiments, the HWD 250 includes a front rigid body 305 and a band 310. The front rigid body 305 includes the electronic display 275 (not shown in FIG. 3), the lens 280 (not shown in FIG. 3), the sensors 255, the wireless interface 265, and the processor 270. In the embodiment shown by FIG. 3, the wireless interface 265, the processor 270, and the sensors 255 are located within the front rigid body 205, and may not be visible externally. In other embodiments, the HWD 250 has a different configuration than shown in FIG. 3. For example, the wireless interface 265, the processor 270, and/or the sensors 255 may be in different locations than shown in FIG. 3.

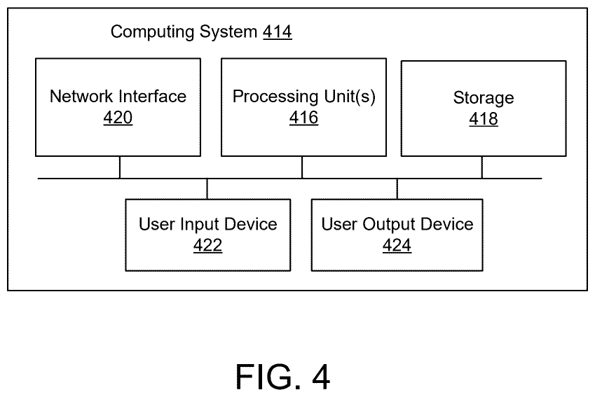

Various operations described herein can be implemented on computer systems. FIG. 4 shows a block diagram of a representative computing system 414 usable to implement the present disclosure. In some embodiments, the source devices 110, the sink device 120, the console 210, the HWD 250 are implemented by the computing system 414. Computing system 414 can be implemented, for example, as a consumer device such as a smartphone, other mobile phone, tablet computer, wearable computing device (e.g., smart watch, eyeglasses, head wearable display), desktop computer, laptop computer, or implemented with distributed computing devices. The computing system 414 can be implemented to provide VR, AR, MR experience. In some embodiments, the computing system 414 can include conventional computer components such as processors 416, storage device 418, network interface 420, user input device 422, and user output device 424.

Network interface 420 can provide a connection to a wide area network (e.g., the Internet) to which WAN interface of a remote server system is also connected. Network interface 420 can include a wired interface (e.g., Ethernet) and/or a wireless interface implementing various RF data communication standards such as Wi-Fi, Bluetooth, or cellular data network standards (e.g., 3G, 4G, 5G, 60 GHz, LTE, etc.).

The network interface 420 may include a transceiver to allow the computing system 414 to transmit and receive data from a remote device using a transmitter and receiver. The transceiver may be configured to support transmission/reception supporting industry standards that enables bi-directional communication. An antenna may be attached to transceiver housing and electrically coupled to the transceiver. Additionally or alternatively, a multi-antenna array may be electrically coupled to the transceiver such that a plurality of beams pointing in distinct directions may facilitate in transmitting and/or receiving data.

A transmitter may be configured to wirelessly transmit frames, slots, or symbols generated by the processor unit 416. Similarly, a receiver may be configured to receive frames, slots or symbols and the processor unit 416 may be configured to process the frames. For example, the processor unit 416 can be configured to determine a type of frame and to process the frame and/or fields of the frame accordingly.

User input device 422 can include any device (or devices) via which a user can provide signals to computing system 414; computing system 414 can interpret the signals as indicative of particular user requests or information. User input device 422 can include any or all of a keyboard, touch pad, touch screen, mouse or other pointing device, scroll wheel, click wheel, dial, button, switch, keypad, microphone, sensors (e.g., a motion sensor, an eye tracking sensor, etc.), and so on.

User output device 424 can include any device via which computing system 414 can provide information to a user. For example, user output device 424 can include a display to display images generated by or delivered to computing system 414. The display can incorporate various image generation technologies, e.g., a liquid crystal display (LCD), light-emitting diode (LED) including organic light-emitting diodes (OLED), projection system, cathode ray tube (CRT), or the like, together with supporting electronics (e.g., digital-to-analog or analog-to-digital converters, signal processors, or the like). A device such as a touchscreen that function as both input and output device can be used. Output devices 424 can be provided in addition to or instead of a display. Examples include indicator lights, speakers, tactile “display” devices, printers, and so on.

Some implementations include electronic components, such as microprocessors, storage and memory that store computer program instructions in a computer readable storage medium (e.g., non-transitory computer readable medium). Many of the features described in this specification can be implemented as processes that are specified as a set of program instructions encoded on a computer readable storage medium. When these program instructions are executed by one or more processors, they cause the processors to perform various operation indicated in the program instructions. Examples of program instructions or computer code include machine code, such as is produced by a compiler, and files including higher-level code that are executed by a computer, an electronic component, or a microprocessor using an interpreter. Through suitable programming, processor 416 can provide various functionality for computing system 414, including any of the functionality described herein as being performed by a server or client, or other functionality associated with message management services.

It will be appreciated that computing system 414 is illustrative and that variations and modifications are possible. Computer systems used in connection with the present disclosure can have other capabilities not specifically described here. Further, while computing system 414 is described with reference to particular blocks, it is to be understood that these blocks are defined for convenience of description and are not intended to imply a particular physical arrangement of component parts. For instance, different blocks can be located in the same facility, in the same server rack, or on the same motherboard. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Implementations of the present disclosure can be realized in a variety of apparatus including electronic devices implemented using any combination of circuitry and software.

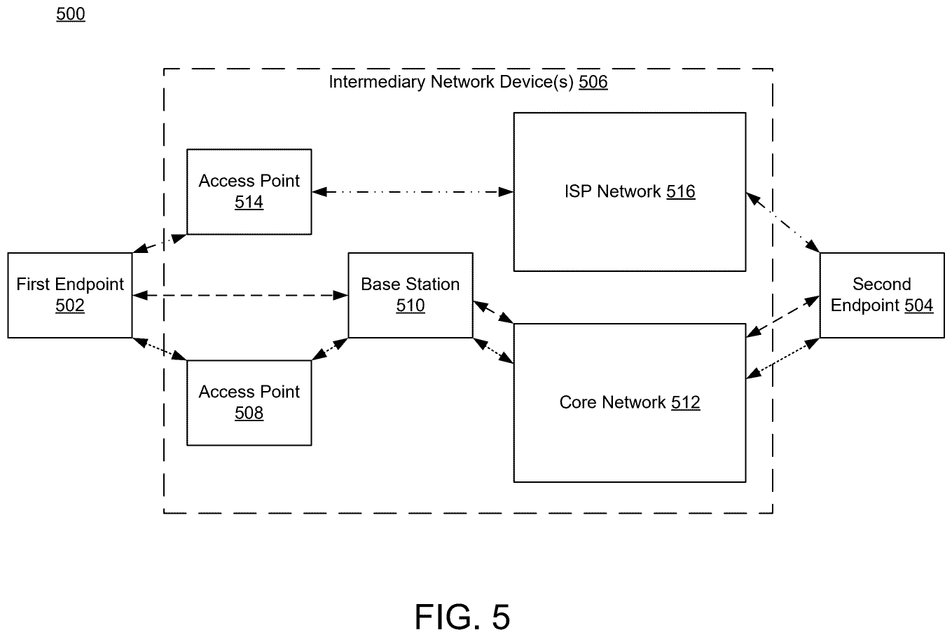

Referring generally FIG. 5-FIG. 10, this disclosure relates to systems and methods for latency improvement. In particular, the systems and methods described herein may provide latency improvement for time critical extended reality (XR) (e.g., virtual reality (VR), mixed reality (MR), and/or augmented reality (AR)) traffic. In various embodiments, the systems and methods described herein may be applicable in various cellular technologies. For XR applications where congestion control between client devices (e.g., HMD, smart glasses) and application servers is used to improve user quality of experience (QoE), packets are marked for round-trip feedback to the sender device to perform codec rate adaptation. However, end-to-end round-trip across the cellular-based network in DL and UL directions may be impacted by large latencies and packet loss. The systems and methods described herein recognizes that congestion is usually centered around the base stations and therefore for UL/DL traffic. The systems and methods described herein provide a modified feedback system to exclude certain hops at each end, and use modified signaling formats, for more responsive and reliable congestion control.

In various implementations, certain nodes (such as UE-gNB) may be more exposed to congestion in wireless UL and DL. The UE-gNB may detect and remedy congestion via ECN bit marking. ECN bits may be conveyed via IP headers towards the destination, which can then inform the source of the congestion via a RTCP report. According to the systems and methods described herein, upon congestion at a base station queue, the base station can insert an ECN bit marking. The base station can forward an ICMP packet to the sender. The sender can parse the ICMP packets (e.g., including the embedded ECN bit marking), and can adapt the codec rate based on the ICMP information.

In various embodiments of the systems and methods described herein, a first endpoint (or endpoint device, such as a HMD, smart glasses, user device, or application server) may be configured to transmit, via one or more intermediary network devices, first traffic generated by the first endpoint for receipt by a second endpoint (or endpoint device, such as another HMD, smart glasses, user device, or application server). The first endpoint may receive a packet generated by a first intermediary network device, where the packet indicates congestion experienced by the first intermediary network device. The first endpoint may generate and transmit second traffic according to the packet received from the first intermediary device.

According to the systems and methods described herein, the present solution may reduce latency and congestion by eliminating additional hops of congestion experienced indication that may be otherwise implemented in congestion indication signaling between endpoints. For example, under other implementations of congestion indication signaling, the congestion indication may be provided by an intermediary device to a receiver device, which may correspondingly signal such congestion back to the transmitter device. According to the present solution, responsive to the intermediary device identifying congestion, the intermediary device may generate and transmit a packet indicating congestion to the transmitter device, thereby providing such an indication to the transmitting device without having to first provide such an indication to the receiving device incorporated into the packet(s) forwarded by the intermediary device to the receiving device. Additional technical benefits of the present solution are described in greater detail below.

Referring now to FIG. 5, depicted is a network diagram of a system 500 for latency improvement, according to an example implementation of the present disclosure. As shown in FIG. 5, the system 500 may include a first endpoint 502 and a second endpoint 504 communicably coupled to one another via one or more intermediary network devices 506. The first endpoint 502 may include a user device (such as a HMD, console, or other user device) or an application server. The second endpoint 504 may include a similar user device and/or an application server. For example, the first endpoint 502 and second endpoint 504 may include a combination of user device and application server, or a combination of multiple user devices.

The intermediary network devices 506 (referred to generally as “intermediary device 506” or “intermediary devices 506”) may include or define different network paths, based on or according to the particular types of networks used by the endpoints 502, 504 for a communications link or channel. The network paths are illustrated in dot-dot-dash, dash, and dot links, respectively, and described in greater detail below.

In a first network path (shown in dot-dot-dash), the endpoints 502, 504 may be communicably coupled to one another via an internet service provider (ISP) network 516, using one or more access points 514. In this example, the first endpoint 502 may include a user device communicably coupled to a wireless local area network (WLAN) access point 514, which maintains a connection with the ISP network 516, and the ISP network 516 may maintain or establish a connection with the second endpoint 504 (e.g., either a direct connection with the second endpoint 504, a connection with a front-end of the second endpoint 504, and/or a connection with a corresponding access point of the second endpoint 504).

In a second network path (shown in dash) and third network path (shown in dot), the endpoints 502, 504 may be communicably coupled with one another via a core network 512 (e.g., a cellular network, such as a long term evolution (LTE) network, 4G network, 5G network, etc.). In the second network path, the first endpoint 502 may be communicably coupled with a base station 510, which connects the first endpoint 502 to the core network 512. In the third network path, the first endpoint 502 may be communicably coupled with an access point 508, which connects the first endpoint 502 to the base station 510 (which correspondingly connects to the core network 512). Like the ISP network 516, the core network 512 may be configured to maintain or establish a connection with the second endpoint 504 (e.g., either a direct connection with the second endpoint 504, a connection with a base station 510 servicing the second endpoint 504, a connection with a front-end of the second endpoint 504, and/or a connection with a corresponding access point of the second endpoint 504).

While these network paths are shown and described, it should be understood that further permutations and alternative network paths may be implemented to facilitate communication between endpoints 502, 504 according to various network implementations and configurations.

As described in greater detail below, the first endpoint 502 (or alternatively, the second endpoint 504, referred to generally as the transmitting endpoint 502) may be configured to generate traffic for transmission (via the intermediary devices 506) to the other endpoint (e.g., the second endpoint 504, or alternatively, the first endpoint 502, referred to generally as the receiving endpoint 504). In various instances, one of the intermediary devices 506 may experience congestion when forwarding traffic from the transmitting endpoint 502 to the receiving endpoint 504. In such implementations, the intermediary device 506 (e.g., which experiences the congestion) may be configured to generate and transmit a packet to the transmitting endpoint 502, indicating that the intermediary device 506 experienced congestion. The transmitting endpoint 502 may be configured to generate subsequent (e.g., second) traffic for transmission to the receiving endpoint 504, according to the packet received from the intermediary device 506.

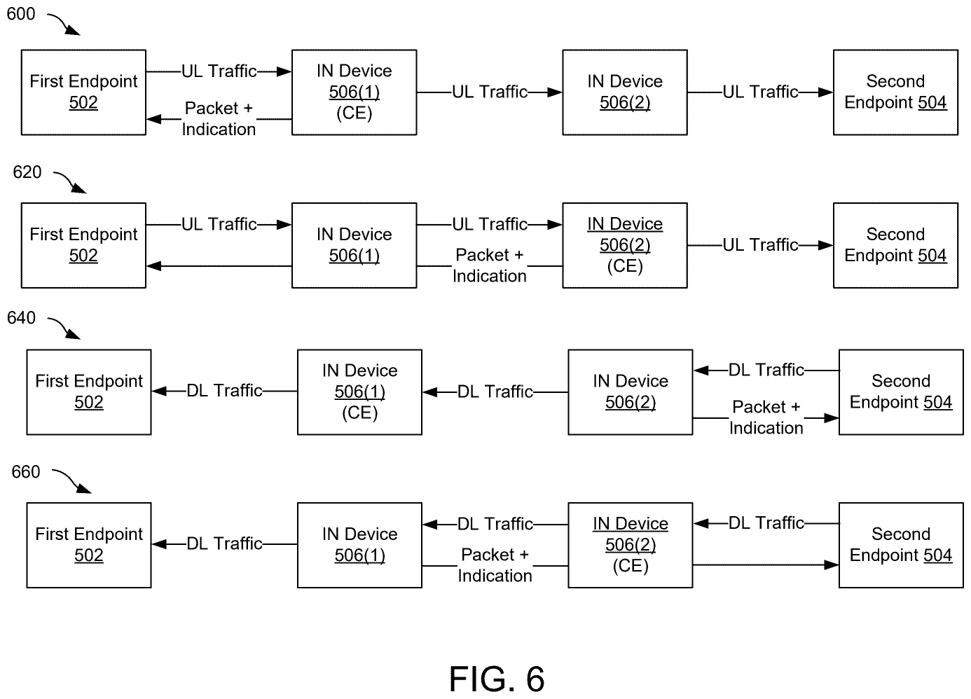

Referring now to FIG. 6, depicted are various examples 600, 620, 640, 660 of congestion indication for downlink and uplink traffic, according to an example implementation of the present disclosure.

In the first example 600 and second example 620, relating to uplink traffic (e.g., from a user device to an application server or another user device), the first endpoint 502 may generate first uplink (UL) traffic. The first endpoint 502 may transmit the first UL traffic via a first intermediary device 506(1) and second intermediary device 506(2) to the second endpoint 504. In the first example 600, the first intermediary device 506(1) may experience congestion when forwarding the first UL traffic to the second intermediary device 506(2). In this example, the first intermediary device 506(1) may transmit the first UL traffic to the second intermediary device 506(2), and also generate and transmit a packet with an indication of congestion experienced back to the first endpoint 502. In the second example 620, the second intermediary device 506(2) may experience congestion when transmitting the first UL traffic from the first intermediary device 506(1) to the second endpoint 504. In this example, the second intermediary device 506(2) may transmit the first UL traffic to the second endpoint 504, and also generate and transmit a packet with an indication of congestion experienced back to the first endpoint 502 via the first intermediary device 506(1).

In the third example 640 and fourth example 640, relating to downlink traffic (e.g., from an application server or another user device to a user device), the second endpoint 504 may generate first downlink (UL) traffic. The second endpoint 504 may transmit the first DL traffic via the second and first intermediary devices 506(2), 506(1) to the first endpoint 502. In the third example 640, the second intermediary device 506(2) may experience congestion when forwarding the first DL traffic to the first intermediary device 506(1). In this example, the second intermediary device 506(2) may transmit the first DL traffic to the first intermediary device 506(1), and also generate and transmit a packet with an indication of congestion experienced back to the second endpoint 504. In the fourth example 640, the first intermediary device 506(1) may experience congestion when transmitting the first DL traffic from the second intermediary device 506(2) to the first endpoint 502. In this example, the first intermediary device 506(1) may transmit the first DL traffic to the first endpoint 502, and also generate and transmit a packet with an indication of congestion experienced back to the second endpoint 504 via the second intermediary device 506(2).

In each of these examples, the packet transmitted by the intermediary device 506 which is experiencing congestion may include an indication of congestion experienced by the intermediary device 506. The packet and corresponding indication may depend on the particular type of network and/or communication protocols. For example, and in some embodiments, the packet may be or include an internal control message protocol (ICMP) packet generated by the intermediary device 506. The ICMP packet may include, e.g., a header which includes a field that provides the indication. For example, the ICMP header may include an ICMP header having a first field corresponding to a type, a second field corresponding to a code, and a third field corresponding to a checksum. The ICMP packet may be or include a source quench message. The source quench message may include an IP header and bits which correspond to the UL/DL datagram from the transmitting endpoint. In this regard, the intermediary device 506 may be configured to transmit the source quench message with the indication of congestion experienced, as described in greater detail below, to the transmitting endpoint. The transmitting endpoint may use the IP header and bits which correspond to the datagram from the source quench message, to match the source quench message to a corresponding data transmission flow (e.g., for generating subsequent traffic according to the indication that congestion is experienced by the intermediary device 506).

The intermediary device 506 may be configured to incorporate the indication of congestion experienced in the second field corresponding to the code for a particular type (e.g., a type 4) of ICMP packet. For instance, in some implementations, the intermediary device 506 may be configured to incorporate the indication as an explicit congestion notification (ECN) codepoint into the second field (e.g., a value of “00” to indicate that the intermediary device 506 is not ECN-capable, a value of “01” to indicate that the intermediary device 506 is ECN-capable for transport 0, a value of “10” to indicate that the intermediary device 506 is ECN-capable for transport −1, and a value of “11” to indicate that the intermediary device 506 experienced congestion). Such an implementation may provide a one-to-one mapping with ECN bits for low latency, low loss, scalable throughput (L4S) communication. As another example, and in some implementations, the intermediary device may be configured to incorporate the indication as a fixed value of the second field for a particular type of ICMP header (e.g., code=0 for a type 4 ICMP header). Such an implementation may provide a simple implementation for indicating congestion by a intermediary device 506.

In each of the examples 600, 620, 640, 660, and as described in greater detail below, the transmitting endpoint (e.g., the first endpoint 502 in the first and second examples 600, 620, and the second endpoint 504 in the third and fourth examples 640, 660) may be configured to generate second UL traffic according to the packet with the indication, for transmission to the receiving endpoint (e.g., the second endpoint 504 in the first and second examples 600, 620, and the first endpoint 502 in the third and fourth examples 640, 660).

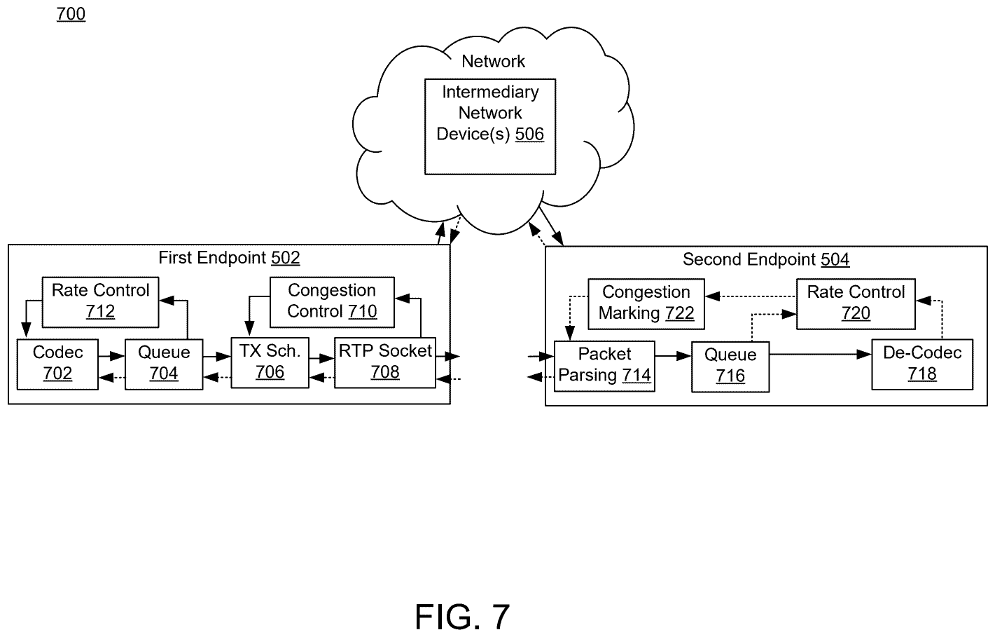

Referring now to FIG. 7, depicted is a block diagram of a system 700 for latency improvement, according to an example implementation of the present disclosure. As shown in FIG. 7, the system 700 may include several of the hardware, components, and elements shown in FIG. 5, such as the first endpoint 502, the second endpoint 504, and intermediary network devices 506. The first endpoint 502 may include a codec 702, a queue 704, a transmission scheduler 706, a real-time transfer protocol (RTP) socket 708, a congestion control engine 710, and a rate control engine 712. The second endpoint 504 may included a packet parsing engine 714, a queue 716, a decoder codec 718, a rate control engine 720, and a congestion marking engine 722.

The codec 702 is a device or software that encodes and decodes digital data streams. An encoder of the codec 702 may be configured to compress and/or encode data, e.g., to reduce the amount of bandwidth needed for transmission. Similarly, a decoder of the codec 702 may be configured to decompress and/or decode data encoded by the encoder (e.g., at the transmitting endpoint) to restore the original data. The codec 702 may be used for various types of applications in various setting. For example, the codec 702 may be used in video conferencing/avatar-based call applications to compress video (and/or audio/control) data before sending the video data over the network to the receiving endpoint. As another example, the codec 702 may be used in gaming-based applications to compress control and/or game content data before sending such content over the network to the receiving endpoint. The queue 704 may be or include a data structure used to store packets/datagrams temporarily before such packets are transmitted over the network. The queue 704 may be configured to manage the flow of data, such that packets are sent in an orderly manner and preventing congestion at the transmitting endpoint 502. For instance, in a streaming service, the queue 704 of an application server may hold video packets before they are sent to a receiving endpoint. In some embodiments, the queue 704 may be operated via a first-in, first-out (FIFO) implementation, where packets are processed in the order in which the packets are queued.

The transmission scheduler 706 may be configured to determine the timing and/or order of packet transmissions. The transmission scheduler 706 may be configured to optimize the use of network resources, by scheduling packets based on priority and network conditions. For example, the transmission scheduler 706 may be configured to analyze network traffic conditions (e.g., RTT/packet drop/etc.) and adjust the transmission schedule to avoid congestion and ensure timely delivery of high-priority/latency-sensitive packets (while potentially delaying transmission of low-priority packets). For example, in a real-time gaming application, the transmission scheduler 706 may be configured to schedule latency-sensitive game data (such as control inputs) ahead of less latency-sensitive data (such as microphone/user audio data), in implementations in which network traffic conditions are reduced. The real-time transfer protocol (RTP) socket 708 may be configured to facilitate transmission of real-time data, such as audio and video, over the network. The RTP socket 708 may be configured to apply, e.g., sequence numbers and/or timestamps to packets prior to their transmission to the network.

The congestion control engine 710 may be configured to monitor network conditions and adjusts the transmission rate (e.g., the rate at which packets are pulled from the queue 704 by the transmission scheduler 706) to prevent congestion and packet loss. The congestion control engine 710 may be configured to monitor network conditions based on or according sensed network conditions (e.g., packet loss, RTT, throughput, and so forth) and/or signaled congestion experienced indicated in packet(s) from the intermediary devices 506 (e.g., as described above with reference to FIG. 6). Similarly, the rate control engine 712 may be configured to dynamically adjust the codec rate based on network conditions. For instance, the rate control engine 712 may be configured to decrease the codec rate responsive to receiving an indication from an intermediary device 506 indicating congestion experienced thereby. For example, in a streaming service, the rate control engine 712 may be configured to adjust the video bitrate based on congestion experienced indications received from the intermediary device 506 to which previous video data was transmitted for transmitting to the receiving endpoint 504. In this regard, the rate control engine 712 may be configured to monitor network performance (e.g., as indicated by the intermediary devices 506) and adjusting the codec rate accordingly, to match the current conditions.

The packet parsing engine 714 on the second endpoint 504 may be configured to analyze incoming packets (e.g., received from the transmitting endpoint 502) to extract relevant information and detect any congestion indications (which may be similarly incorporated into the packet(s) by the intermediary devices 506. The packet parsing engine 714 may be configured to parse/analyze/inspect packet headers and payloads to extract congestion experienced indications provided by an intermediary device 506 along the network path between the endpoints 502, 504. Like queue 704, the queue 716 may be configured to temporarily store incoming data packets from the transmitting endpoint 502 before they are processed by the receiving endpoint 504. The decoder codec 718 may be configured to decode the received data streams encoded by codec 702. The rate control engine 720 on the second endpoint 504 may be configured to adjusts the transmission rate and/or decoder codec rate, based on the feedback received from the network (e.g., indicated in the packet(s) received by the receiving endpoint 504 via the network from the transmitting endpoint 502). For example, the rate control engine 720 may adjust the codec video decoding bitrate (e.g., to match the codec rate used by the encoder codec 702) based on network performance as indicated in the packet(s) received via the intermediary device(s) 506 from the transmitting endpoint 502. The congestion marking engine 722 may be configured to mark outbound packets (such as acknowledgement packets, packets including outbound/DL traffic, etc.) to indicate congestion experienced along the network path from the transmitting endpoint 502. For example, the congestion marking engine 722 may be configured to mark outbound packets to indicate congestion along the network path, to confirm the corresponding congestion experienced indication provided in the packet generated by the intermediary device 506 to the transmitting endpoint 502.

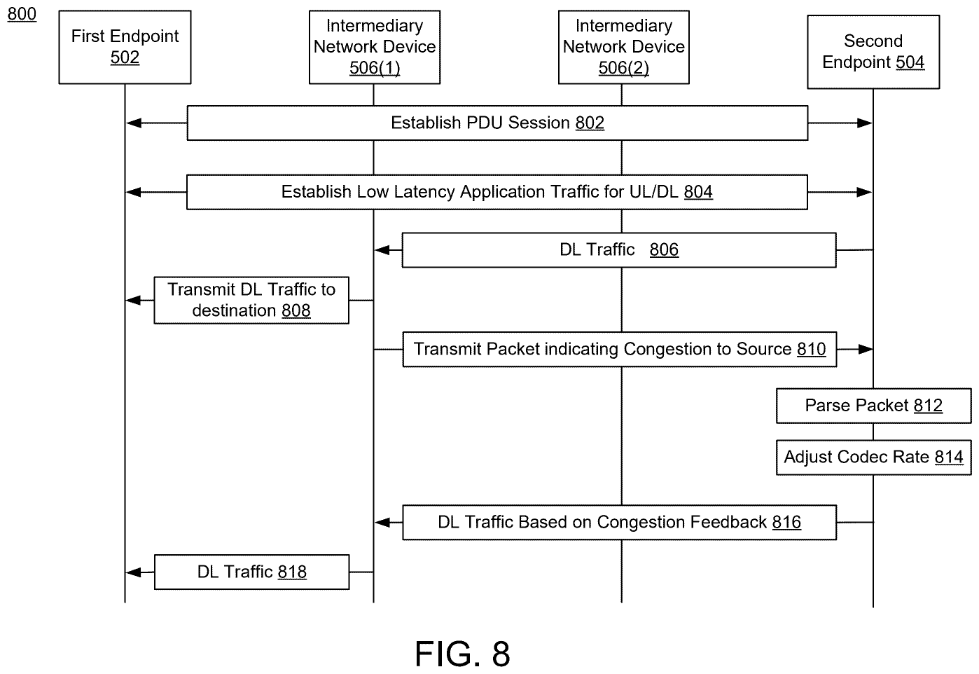

FIG. 8 is a process flow diagram 800 for latency improvement for downlink traffic, according to an example implementation of the present disclosure. As shown in FIG. 8, the process flow diagram 800 may be implemented via the systems, components, elements, or hardware described above with reference to FIG. 5-FIG. 7, such as the first endpoint 502, second endpoint 504, and intermediary devices 506(1), 506(2).

At process 802, the first endpoint 502 and second endpoint 504 may be configured to establish a protocol data unit (PDU) session between the endpoints 502, 504 via the intermediary devices 506. In some embodiments, the first endpoint 502 and second endpoint 504 may be configured to establish the PDU session as part of an application/service/resource executing on the endpoints 502, 504 which involves exchanging data/traffic between the endpoints 502, 504 (e.g., at least, downlink traffic being sent by the second endpoint 504 to the first endpoint 502). For example, the resource may include a streaming resource which streams traffic from the second endpoint 504 to the first endpoint 502. As another example, the resource may include a video conferencing (or AR/VR conferencing) resource which involves exchanging traffic both uplink and downlink between the endpoints 502, 504.

At process 804, the first endpoint 502 and second endpoint 504 may be configured to establish a flow for low latency application traffic for uplink and downlink traffic. In some embodiments, the first endpoint 502 and second endpoint 504 may be configured to establish the flow (e.g., a quality of service (QoS) flow) for the PDU session for carrying/exchanging latency-sensitive traffic between the endpoints 502, 504. The endpoints 502, 504 may be configured to establish the flow based on the application type, services which are to be used by the application, etc., which indicates that certain traffic is latency sensitive. The endpoints 502, 504 may be configured to establish the flow for latency sensitive application traffic by requesting corresponding network allocations via the intermediary device(s) 506 from the network (e.g., the core network and/or ISP network described above with reference to FIG. 5). The endpoints 502, 504 may be configured to establish the flow based on the allocated network resources provided by the network. In some embodiments, the request for the low latency flow may include a request for low latency, low loss, scalable throughput (L4S) signaling by intermediary devices. For example, the request may include a packet, frame, field, etc. which requests L4S signaling such that intermediary device(s) signal congestion experienced at the intermediary device(s) when experienced. The intermediary device(s) may be configured to grant or deny the request for L4S signaling according to, e.g., device configuration, network resources, intermediary device capabilities, and so forth.

At process 806, the second endpoint 504 may transmit downlink (DL) traffic via the intermediary devices 506 to the first endpoint 502. In some embodiments, the second endpoint 504 may be configured to generate the DL traffic (e.g., first traffic) according to first application configurations (e.g., a first codec rate, for instance). The second endpoint 504 may be configured to generate the DL traffic responsive to executing the application or otherwise providing various application services in connection with the application's execution. For instance, where the application relates to an AR/VR conferencing application, the second endpoint 504 may be configured to generate DL traffic based on video data captured by the second endpoint 504. The second endpoint 504 may be configured to transmit the DL traffic generated responsive to execution of the application, via the intermediary devices 506, downlink to the first endpoint 502. In some implementations, an intermediary device 506 (e.g., the first intermediary device 506(1)) may be configured to detect congestion for DL traffic on the flow established at process 804. For example, an intermediary device 506 along a network path corresponding to the PDU session established at process 802, may be configured to experience congestion in connection with transmission of the packet(s) received from the second endpoint 504 (and other packets from other endpoints) to a destination (e.g., the first endpoint 502 and/or other endpoints serviced by the intermediary device 506).

At process 808, the intermediary device 506 may be configured to transmit the DL traffic to the destination (e.g., the first endpoint 502). The intermediary device 506 may be configured to transmit the DL traffic, including the latency sensitive traffic sent on the flow established at process 804, to the destination (e.g., the first endpoint 502). At process 810, the intermediary device 506 may be configured to generate and transmit a packet indicating congestion experienced by the intermediary device 506 to the source (e.g., the second endpoint 504). In some embodiments, the intermediary device 506 may be configured to generate the packet as an internet control message protocol (ICMP) packet. The ICMP packet may be or include a source quench message sent by the intermediary device 506 to the source (e.g., the second endpoint 504). The intermediary device 506 may be configured to generate the packet by incorporating the indication in a header of the packet (e.g., an ICMP header of the ICMP packet). The header may include a field indicating a type of packet (e.g., a type of ICMP packet), a code (e.g., a code for configuring the indication of congestion), and a checksum value. The intermediary device 506 may be configured to generate the packet to indicate congestion to the source, by configuring the code to indicate the congestion experienced by the intermediary device 506. The intermediary device 506 may be configured to transmit the packet (with the indication of congestion) to the source (e.g., the second endpoint 504).

At process 812, the second endpoint 504 may be configured to parse the packet (e.g., received responsive to process 810). The second endpoint 504 may be configured to parse the packet to determine the packet type and code, to determine whether congestion is experienced by the intermediary device 506. For example, the second endpoint 504 may be configured to determine whether the packet type and code correspond to values which indicate congestion experienced (e.g., a packet type indicating a value of 4, and the code indicating a value corresponding to congestion experienced, such as a predefined value of “0” or “11”, depending on the implementation). At process 814, the second endpoint 504 may be configured to adjust a codec rate based on the packet. For example, the second endpoint may be configured to reduce the codec rate (e.g., relative to the rate used to generate the first traffic transmitted at process 806), responsive to the packet indicating congestion experienced by the endpoint.

At process 816, the second endpoint 504 may be configured to generate and transmit subsequent DL traffic based on the congestion feedback received in the packet and according to the adjusted codec rate. Process 816 may be similar to process 806, provided that the codec rate is updated/adjusted at process 814 according to the packet transmitted by the intermediary device 506(1) at process 810. At process 818, like process 808, the intermediary device 506 may be configured to transmit the DL traffic to the first endpoint 502.

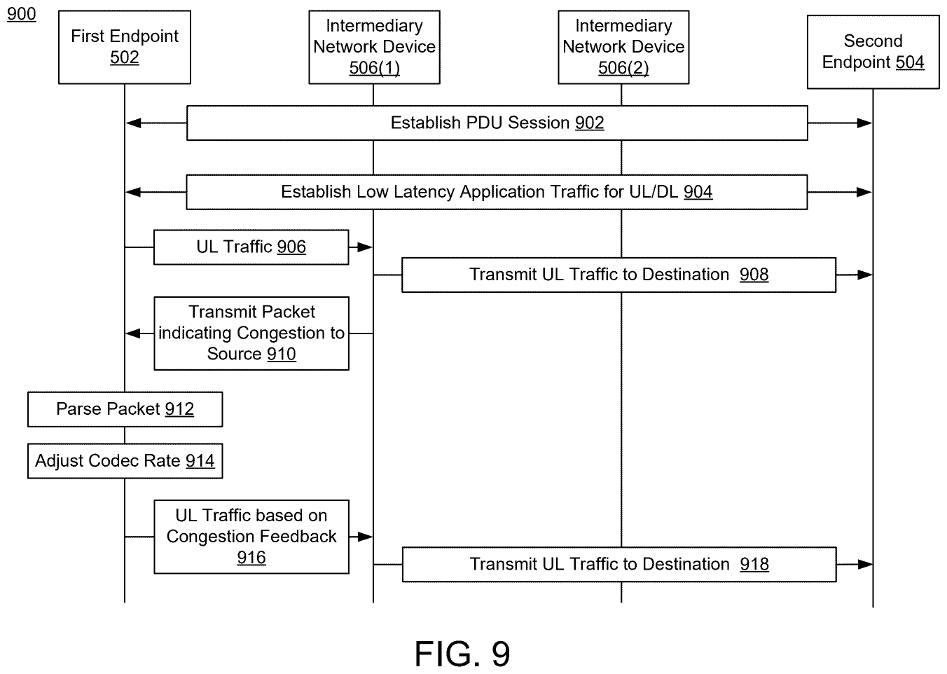

FIG. 9 is a process flow diagram 900 for latency improvement for uplink traffic, according to an example implementation of the present disclosure. Like the process flow diagram 800, the As shown in FIG. 8, the process flow diagram 900 may be implemented via the systems, components, elements, or hardware described above with reference to FIG. 5-FIG. 7, such as the first endpoint 502, second endpoint 504, and intermediary devices 506(1), 506(2). The process flow diagram 900 shown in FIG. 9 may include several steps which are similar to those described above with reference to FIG. 8. For example, process 902, which may include establishing a PDU session between the endpoints 502, 504 may be similar to process 802. Likewise, process 904, which may include establishing a flow for low latency traffic, may be similar to process 804.

At process 906, the first endpoint 502 may be configured to generate and transmit first uplink (UL) traffic via the intermediary devices 506 to the second endpoint 504. Process 906 may be similar to process 806, except that the traffic generated by the first endpoint 502 is UL traffic (in contrast to the DL traffic generated at process 806). In some implementations, an intermediary device 506 (e.g., the first intermediary device 506(1)) may be configured to detect congestion for the UL traffic on the flow established at process 904. At process 908, the intermediary device 506 may be configured to transmit the first UL traffic to the destination (e.g., the second endpoint 504). Process 908 may be similar to process 808, except that the traffic is sent uplink to the second endpoint 504 in process 908, whereas the traffic is sent downlink to the first endpoint 502 in process 808.

At process 910, the intermediary device 506 may be configured to generate and transmit a packet indicating congestion experienced by the intermediary device 506 to the source (e.g., the first endpoint 502). The intermediary device 506 may be configured to generate and transmit the packet in a manner similar to process 810. For example, the intermediary device 506 may be configured to generate an ICMP packet (e.g., a source quench message) with a code and packet type configured in the ICMP header which indicates congestion is experienced by the intermediary device 506. The intermediary device 506 may be configured to transmit the packet to the first endpoint 502.

At process 912, the first endpoint 502 may be configured to parse the packet and, at process 914, the first endpoint 502 may be configured to adjust a codec rate. Processes 912 and 914 may be similar to processes 812 and 814 of FIG. 8. At process 916, the first endpoint may be configured to generate and transmit subsequent UL traffic based on the congestion feedback provided by the intermediary device 506. In other words, the first endpoint may be configured to generate subsequent latency-sensitive UL traffic using the updated/adjusted codec rate, which is adjusted according to the packet, for transmission to the second endpoint 504 via the intermediary devices 506. At process 918, the intermediary device 506 may be configured to transmit the subsequent UL traffic to the second endpoint 504.

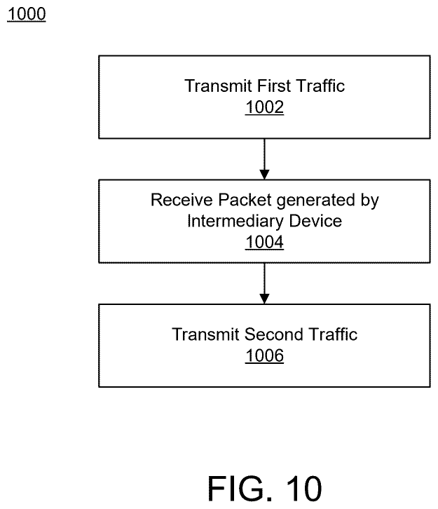

FIG. 10 is a flowchart showing an example method 1000 for latency improvement, according to an example implementation of the present disclosure. The method 1000 may be executed by the components, elements, or hardware described above with reference to FIG. 5-FIG. 9, such as the first endpoint 502 or the second endpoint 504. As a brief overview, at step 1002, an endpoint may transmit first traffic. At step 1004, the endpoint may receive a packet generated by an intermediary device. At step 1006, the endpoint may transmit second traffic.

At step 1002, an endpoint may transmit first traffic. In some embodiments, a first endpoint may transmit first traffic generated by the first endpoint, via one or more intermediary network devices, to a second endpoint for receipt thereby. The first endpoint may be or include the first endpoint 502 or the second endpoint 504 described above. In other words, the first traffic may be or include downlink or uplink traffic. In some embodiments, the first traffic may be or include latency-sensitive traffic (e.g., to be sent on a low latency QoS flow of a PDU session established between the endpoints). The first endpoint may transmit the first traffic via one or more intermediary devices (e.g., one or more access points, base stations, ISP/core networks) to the second endpoint.

At step 1004, the endpoint may receive a packet generated by an intermediary device (e.g., an access point, a base station). In some embodiments, the first endpoint may receive the packet following transmission of the first traffic at step 1002. The first endpoint may receive the packet in connection with the intermediary device transmitting the traffic along the network path to the second endpoint. The packet may include an indication which indicates that congestion is experienced by the intermediary device. The intermediary device may generate the packet responsive to detecting congestion at the intermediary device. The packet may be or include an internet control message protocol (ICMP) message generated by the intermediary device. For example, the packet may include a source quench message indicating congestion is experienced by the intermediary device. The intermediary device may generate the packet according to a request for explicit congestion notification made by the endpoint(s) as part of connection establishment (e.g., as part of requesting a low latency QoS flow).

The intermediary device may generate the packet, to indicate congestion is experienced by the intermediary device to the source (e.g., the first endpoint) without the first endpoint having to receive such a corresponding indication from the second endpoint. For example, rather than the intermediary device marking packets which are to be delivered to the second endpoint with congestion experienced indications, the intermediary device may generate and transmit the packet to the first endpoint. In this regard, by transmitting the packet to the first endpoint, the intermediary device bypasses the indication first being provided to the second endpoint, which correspondingly indicates the congestion to the first endpoint through signaling back to the first endpoint. Such implementations eliminate communication hops between the intermediary device which experienced congestion and any further downstream intermediary device(s) and the second endpoint. In this regard, and in some embodiments, the intermediary device may generate and transmit the packet to the first endpoint, without providing congestion indication to the second endpoint. In some embodiments, the intermediary device may also mark packets to be delivered to the second endpoint with the congestion indication, to additionally provide the congestion indication to both endpoint(s). However, by providing the separate packet to the first endpoint, the first endpoint may be provided an indication of congestion being experienced by the intermediary device sooner than if the first endpoint were to wait to receive corresponding signaling from the second endpoint. Additionally, such implementations may reduce a likelihood of signaling which indicates the congestion experienced by the intermediary device that originate from the second endpoint being dropped at the communication hops between the second endpoint and the intermediary device which experienced congestion.

At step 1006, the endpoint may transmit second traffic. In some embodiments, the endpoint (e.g., the first endpoint) may transmit second traffic generated by the endpoint according to the packet received at step 1004. For example, the endpoint may generate the second traffic according to the packet, by setting a codec rate (e.g., adjusting/reducing the codec rate from what was used for generating the first traffic) used to generate the second traffic, according to the packet indicating congestion experienced by the intermediary device.

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations or implementations.

The hardware and data processing components used to implement the various processes, operations, illustrative logics, logical blocks, modules and circuits described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit and/or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or embodiment, and references to “an implementation,” “some implementations,” “one implementation” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation can be combined with any other implementation, inclusively or exclusively, in any manner consistent with the aspects and implementations disclosed herein.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Systems and methods described herein may be embodied in other specific forms without departing from the characteristics thereof. References to “approximately,” “about” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

The term “coupled” and variations thereof includes the joining of two members directly or indirectly to one another. Such joining may be stationary (e.g., permanent or fixed) or moveable (e.g., removable or releasable). Such joining may be achieved with the two members coupled directly with or to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References to “or” can be construed as inclusive so that any terms described using “or” can indicate any of a single, more than one, and all of the described terms. A reference to “at least one of ‘A’ and ‘B’” can include only ‘A’, only ‘B’, as well as both ‘A’ and ‘B’. Such references used in conjunction with “comprising” or other open terminology can include additional items.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

References herein to the positions of elements (e.g., “top,” “bottom,” “above,” “below”) are merely used to describe the orientation of various elements in the FIGURES. The orientation of various elements may differ according to other exemplary embodiments, and that such variations are intended to be encompassed by the present disclosure.

What is claimed is:

1. A method, comprising:
transmitting, by a first endpoint via one or more intermediary network devices to a second endpoint, first traffic generated by the first endpoint for receipt by the second endpoint;
receiving, by the first endpoint from a first intermediary network device of the one or more intermediary network devices, a packet generated by the first intermediary network device, the packet indicating congestion experienced by the first intermediary network device; and
transmitting, by the first endpoint via the one or more intermediary network devices to the second endpoint, second traffic generated by the first endpoint according to the packet received from the first intermediary network device.

2. The method of claim 1, wherein the first intermediary network device comprises at least one of an access point or a base station.

3. The method of claim 1, wherein the packet comprises an internet control message protocol (ICMP) packet generated by the first intermediary network device.

4. The method of claim 3, wherein the ICMP packet comprises a source quench message generated by the first intermediary network device and transmitted to the first endpoint.

5. The method of claim 1, wherein the first traffic and the second traffic comprise latency sensitive traffic, and wherein the first intermediary network device generates the packet according to a request for low latency, low loss, scalable throughput (L4S) generated by at least one of the first endpoint or the second endpoint.

6. The method of claim 1, further comprising:
generating, by the first endpoint, the second traffic according to the packet received from the first intermediary network device.

7. The method of claim 6, wherein the first endpoint generates the second traffic by setting a codec rate for generation of the second traffic, which is different than a codec rate used for generating the first traffic.

8. The method of claim 1, wherein the first endpoint comprises a user device or an application server.

9. The method of claim 1, wherein the one or more intermediary network devices comprise the first intermediary device and one or more second intermediary network devices, the one or more second intermediary network devices corresponding to at least one of an internet service provider (ISP) network or a cellular network.

10. The method of claim 1, wherein the first traffic and the second traffic comprise at least one of first and second uplink traffic or first and second downlink traffic.

11. A first endpoint, comprising:
one or more processors configured to:
transmit, via one or more intermediary network devices to a second endpoint, first traffic generated by the first endpoint for receipt by the second endpoint;
receive, from a first intermediary network device of the one or more intermediary network devices, a packet generated by the first intermediary network device, the packet indicating congestion experienced by the first intermediary network device; and
transmit, via the one or more intermediary network devices to the second endpoint, second traffic generated by the first endpoint according to the packet received from the first intermediary network device.

12. The first endpoint of claim 11, wherein the first intermediary network device comprises at least one of an access point or a base station.

13. The first endpoint of claim 11, wherein the packet comprises an internet control message protocol (ICMP) packet generated by the first intermediary network device.

14. The first endpoint of claim 13, wherein the ICMP packet comprises a source quench message generated by the first intermediary network device and transmitted to the first endpoint.

15. The first endpoint of claim 11, wherein the first traffic and the second traffic comprise latency sensitive traffic, and wherein the first intermediary network device generates the packet according to a request for low latency, low loss, scalable throughput (L4S) generated by at least one of the first endpoint or the second endpoint.

16. The first endpoint of claim 11, wherein the one or more processors are configured to:
generate the second traffic according to the packet received from the first intermediary network device.

17. The first endpoint of claim 16, wherein the one or more processors are configured to generate the second traffic by setting a codec rate for generation of the second traffic, which is different than a codec rate used for generating the first traffic.

18. The first endpoint of claim 11, wherein the first endpoint comprises a user device or an application server.

19. The first endpoint of claim 11, wherein the one or more intermediary network devices comprise the first intermediary device and one or more second intermediary network devices, the one or more second intermediary network devices corresponding to at least one of an internet service provider (ISP) network or a cellular network.

20. A non-transitory computer readable medium storing instructions that, when executed by one or more processors of a first endpoint, cause the one or more processors to:
transmit, via one or more intermediary network devices to a second endpoint, first traffic generated by the first endpoint for receipt by the second endpoint;
receive, from a first intermediary network device of the one or more intermediary network devices, a packet generated by the first intermediary network device, the packet indicating congestion experienced by the first intermediary network device; and
transmit, via the one or more intermediary network devices to the second endpoint, second traffic generated by the first endpoint according to the packet received from the first intermediary network device.
